(19) United States
(12) Patent Application Publication
(10) Pub. No.: US 2026/0310147 A1
(43) Pub. Date: Oct. 8, 2026

(54) AGENTIC CONFIGURATION ASSISTANCE MODULE

(71) Applicant: Iru, Inc., Coral Gables, FL (US)

(72) Inventors: James Matthew Dancer, Miami, FL (US); Dennis Earl King, II, Round Rock, TX (US)

(73) Assignee: Iru, Inc., Coral Gables, FL (US)

(21) Appl. No.: 19/638,423

(22) Filed: Apr. 3, 2026

Related U.S. Application Data
(60) Provisional application No. 63/785,093, filed on Apr. 8, 2025.

(51) Int. Cl. G05B 13/02

(52) U.S. Cl. CPC G05B 13/0265

(57) ABSTRACT

A method involves receiving initial user input data at an Agentic Configuration Assistance module (ACAM) of a mobile device management platform via a user interface, generating clarified user input data; generating a Configuration Requirement Metric, determining whether structured configuration data associated with a first configuration is to be used in responding to the clarified user input data, when used, retrieving the structured configuration data and generating combined configuration user input data based on the clarified user input data and information derived from the structured configuration data, and otherwise generating the combined configuration user input data without using the structured configuration data, generating and providing configuration assistance data via the user interface, receiving configuration input specifying a second configuration derived from one or more configuration changes indicated by the configuration assistance data, and updating the first configuration based on the second configuration.

### RELATED APPLICATIONS

This application claims priority to U.S. Provisional Patent application No. 63/785,093, filed Apr. 8, 2025, all of which is incorporated herein by reference in its entirety.

### BACKGROUND

Mobile Device Management (MDM) platforms are centralized software solutions designed to configure, monitor, and secure mobile devices, such as smartphones, tablets, and computers, within an organization. These platforms enable administrators to manage a wide array of user device settings, applications, and security protocols remotely—often through cloud-based interfaces. By leveraging MDM, organizations can enforce policies, deploy software updates, control access to network resources, and ensure data protection for managed devices. MDM solutions are widely adopted across various industries to streamline device administration, enhance security, and maintain compliance with organizational or regulatory standards.

MDM platforms typically provide administrators with a limited assistance interface to access provider, and community-generated content such as user guides, frequently asked questions, and knowledge base information. While these static or infrequently-updated resources may offer general guidance, they often fail to address the specific challenges administrators encounter when managing their unique device environments.

### SUMMARY

In some aspects, the techniques described herein relate to a method, including: receiving, by one or more processors of a mobile device management platform, initial user input data at an Agentic Configuration Assistance module (ACAM) associated with the mobile device management platform via a user interface; generating, by the one or more processors, clarified user input data based on the initial user input data; generating, by the one or more processors, a Configuration Requirement Metric based on the clarified user input data; determining, by the one or more processors based on the Configuration Requirement Metric, whether structured configuration data associated with a first configuration of the mobile device management platform is to be used in responding to the clarified user input data; in response to determining that the structured configuration data is to be used, retrieving, by the one or more processors, the structured configuration data associated with the first configuration from the mobile device management platform, and generating combined configuration user input data based on the clarified user input data and information derived from the structured configuration data; in response to determining that the structured configuration data is not to be used, generating, by the one or more processors, the combined configuration user input data based on the clarified user input data without using the structured configuration data; generating, by the one or more processors, configuration assistance data based on the combined configuration user input data; providing, by the one or more processors, the configuration assistance data via the user interface; receiving, by the one or more processors, a configuration input via the user interface, the configuration input specifying a second configuration of the mobile device management platform and derived at least in part from one or more configuration changes indicated by the configuration assistance data; and updating, by the one or more processors, the first configuration of the mobile device management platform based on the second configuration.

In some aspects, the techniques described herein relate to a non-transitory computer-readable medium storing instructions for executing a computer-implemented method, the computer-implemented method including: receiving, by one or more processors of a mobile device management platform, initial user input data at an Agentic Configuration Assistance module (ACAM) associated with the mobile device management platform via a user interface; generating, by the one or more processors, clarified user input data based on the initial user input data; generating, by the one or more processors, a Configuration Requirement Metric based on the clarified user input data; determining, by the one or more processors based on the Configuration Requirement Metric, whether structured configuration data associated with a first configuration of the mobile device management platform is to be used in responding to the clarified user input data; in response to determining that the structured configuration data is to be used, retrieving, by the one or more processors, the structured configuration data associated with the first configuration from the mobile device management platform, and generating combined configuration user input data based on the clarified user input data and information derived from the structured configuration data; in response to determining that the structured configuration data is not to be used, generating, by the one or more processors, the combined configuration user input data based on the clarified user input data without using the structured configuration data; generating, by the one or more processors, configuration assistance data based on the combined configuration user input data; providing, by the one or more processors, the configuration assistance data via the user interface; receiving, by the one or more processors, a configuration input via the user interface, the configuration input specifying a second configuration of the mobile device management platform and derived at least in part from one or more configuration changes indicated by the configuration assistance data; and updating, by the one or more processors, the first configuration of the mobile device management platform based on the second configuration.

### BRIEF DESCRIPTION OF THE DRAWINGS

FIG. 1 shows a simplified operational environment for an Agentic Configuration Assistance module (ACAM), in accordance with some examples.

FIG. 2 shows a simplified example of a network platform of the operational environment in FIG. 1, in accordance with some examples.

FIG. 3 shows a simplified example of a user device of the network platform shown in FIG. 2, in accordance with some examples.

FIG. 4 shows a simplified example of a management platform of the operational environment in FIG. 1, in accordance with some examples.

FIGS. 5-8 show simplified portions of a process performed using an Agentic Configuration Assistance module, in accordance with some examples.

FIG. 9 shows a simplified hardware implementation of a compute node, in accordance with some examples.

### DETAILED DESCRIPTION

Mobile Device Management (MDM) platforms are centralized software solutions designed to configure, monitor, and secure mobile devices, such as smartphones, tablets, and computers, within an organization. However, the dynamic nature of MDM environments means that administrators often need real-time, context-aware guidance tailored to their current configurations and policies. Unfortunately, conventional support mechanisms require administrators to sift through documentation, search online forums, or contact technical support teams; all of which can be time-consuming and may not yield answers specific to their organization's structure. As a result, administrators frequently lack an efficient way to diagnose issues, optimize configurations, or retrieve relevant device insights based on the real-time state of their managed devices.

Systems and methods are disclosed herein for an Agentic Configuration Assistance module (ACAM) that provides a context-driven interface for providing guidance related to complex MDM configurations using structured input data. As used herein, an “Agentic Interface” of the ACAM refers to a computing interface that enables users (e.g., administrators at an organization) to interact with mobile device management platform modules through a conversational or natural language-driven approach in which the management platform interprets user intent, determines appropriate system operations, and generates relevant responses without requiring direct procedural inputs (i.e., an administrator does not need to provide rigid, step-by-step input). Unlike traditional conversational interfaces, which primarily serve as structured query-response systems, the Agentic Interface as disclosed herein uses a goal-directed approach, allowing it to dynamically refine queries, retrieve relevant data, and adapt responses based on contextual awareness. In some implementations, the Agentic Interface leverages local or remote natural language processing (NLP) modules, machine-learning modules, and/or rule-based heuristics to facilitate fluid, intent-based interactions, enabling users to request complex device management insights or configurations without specifying detailed query structures.

Additionally, the ACAM is advantageously configured to review real-world organizational information technology configurations to provide written and visual guidance based on the specific context of a given organization's existing or planned MDM configurations. The ACAM is configured to receive input data from a variety of sources, which correspond to varied data types, including ASCII data, image-based data (e.g., JPEG, PNG, TIFF), JSON, YAML, XML, plist, mobileconfig, and others.

The ACAM includes three primary components: a data pipeline module that receives a structured user input, interprets the input structure, and compares the input to a translation map to provide plain-language descriptions, a local or remote machine-learning or natural language processing (NLP) module to formulate assistance information based on user queries, and a visualization module that generates text and visual responses. As compared to machine-learning and/or NLP-assisted solutions that receive user input and autonomously or collaboratively generate code, software applications, websites, information technology configurations, and so on, the ACAM receives user input and data associated with a user's pre-existing MDM configuration and provides contextual assistance to the user based on that MDM configuration. As such, whereas design criteria may be an input for conventional applications which subsequently output a generative design or configuration, user queries and a pre-existing MDM configuration are inputs to the ACAM, and contextual guidance is an output of the ACAM.

In some cases, the translation map is implemented as a key-value store (e.g., using a database, a JSON or XML file, etc.). As but one simplified example, user-facing UI text, such as “Require Passcode,” may be received as a key, and a JSON object with the name “forcePasscode,” representing a Boolean value used for implementing a configuration, would be the returned value. In other examples, an NLP module may generate such translations.

To ensure user data privacy, the ACAM utilizes temporary vector stores to provide ephemeral access to MDM configuration files and knowledge base information when needed. In some examples, the ACAM creates a temporary vector store in response to determining that externalized contextual data will be used to formulate a response. The temporary vector store may be instantiated as a separate logical data store, namespace, index, collection, or other container that is associated with a session identifier, request identifier, user identifier, or combinations thereof. The ACAM uploads user configuration files, or derived text, therefrom to the temporary vector store via one or more application programming interface (API) calls, attaches or otherwise makes the temporary vector store accessible to relevant machine-learning or NLP modules, and then deletes, detaches, or renders inaccessible the temporary vector store after use. This approach ensures that no remnant of sensitive data remains following data-store destruction and that user-specific configuration data is exposed to the NLP and/or machine-learning modules only ephemerally.

As used herein, a “knowledge base” refers to a structured data repository that stores and organizes information for retrieval and analysis. The knowledge base may include predefined documentation, historical user interactions, configuration policies, troubleshooting guides, or other reference materials.

A “vector store” in this context refers to a specialized database or other data object designed to efficiently store and retrieve vector representations of data, such as text or images, where each data point is converted into a numerical vector, allowing for fast similarity searches by NLP or machine-learning modules based on semantic meaning rather than exact keyword matches. In some examples, the vector store additionally stores metadata that identifies a source of a vectorized item, a user session associated with the item, an applicable configuration domain, and/or one or more access-control attributes.

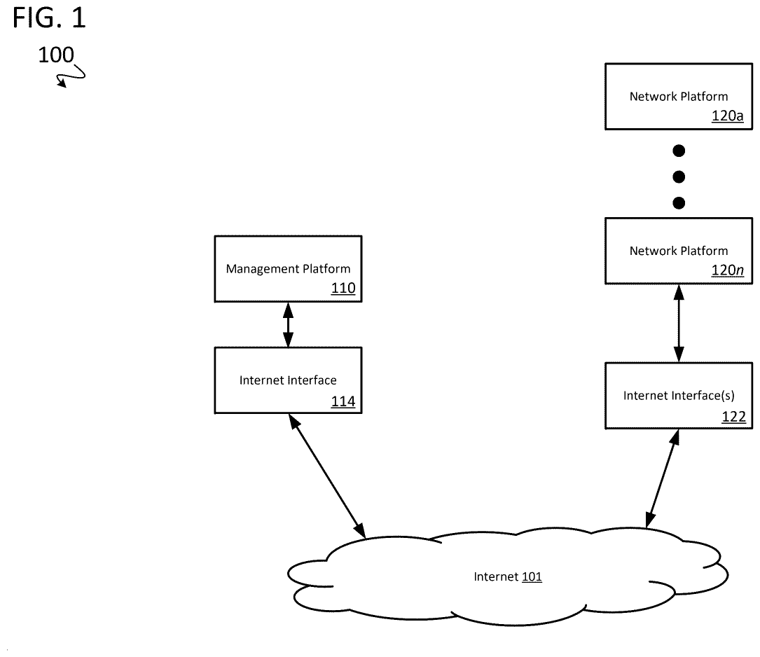

FIG. 1 shows a simplified operational environment 100 for an Agentic Configuration Assistance module (ACAM), in accordance with some examples. In general, the operational environment 100 includes a remote management platform 110 (e.g., a remote MDM server), network platforms 120a-120n, internet interfaces 114 and 122, and a network communication plane designated as Internet 101.

The management platform 110 is configured to manage and deploy device configurations to a network of user devices across one or more network platforms, represented collectively as the network platforms 120a through 120n. The management platform 110 provides many different functionalities, including: maintaining available user device configurations, and also maintaining collections of configurations that are based on security standards; receiving administrator selections of configurations that apply to identified groups of user devices; providing local device agents to the identified user devices to register those user devices; implementing and remediating user device configurations; providing selected configurations and any modules needed to implement the configurations to user devices; and generating reports that detail compliance statuses of those user devices.

The management platform 110 includes one or more management databases that store data that is used during processes for determining sets of configurations to associate with groups of user devices and methods for implementing a set of configurations on a user device and validating compliance with the configurations during scheduled intervals. In some examples, the data stored in the management databases specifies or represents a library of separate configurations or collections of configurations, sets of configurations selected by administrators of network platforms, groups of user devices selected by administrators of network platforms, and reportable data that is determined from data reported by groups of user devices. Individual, pre-built scripts for implementing individual configurations may also be stored in the management databases. The scheduled intervals may range from minutes (e.g., every 5 minutes or 15 minutes), to hours (e.g., every hour), to days (e.g., every day, every other day), to an event-based scheduled interval (e.g., on user device boot-up). In some examples, two or more scheduled intervals may be used simultaneously (e.g., checking configurations on user device boot-up and then every 15 minutes thereafter).

The management platform 110 includes computer software instructions that are used to carry out different aspects of methods for determining sets of configurations to associate with groups of user devices and for implementing a set of configurations on a user device and validating compliance with the configurations during scheduled intervals.

The management platform 110 communicates with the broader network environment via the internet interface 114 which facilitates the transmission of data over the Internet 101. Through this interface, the management platform 110 sends configuration data to user devices of the connected network platforms 120a-120n, ensuring that the user devices receive appropriate settings in accordance with organizational policies. The management platform 110 may also collect status information from each user device, enabling the administrator to monitor compliance and troubleshoot any configuration issues that may arise on the network platform.

Likewise, each network platform 120a-120n communicates with the management platform 110 through one or more internet interfaces 122. In some scenarios, each of the network platforms 120a-120n may represent a separate organization (e.g., a school, a hospital, a company, etc.). In other scenarios, two or more of the network platforms 120a-120n may be associated with the same organization (e.g., remote regional divisions, local organizational divisions, etc.).

The management platform 110 may be implemented as a third-party software-as-a-service (SaaS) product used by administrators of the network platforms 120a-120n.

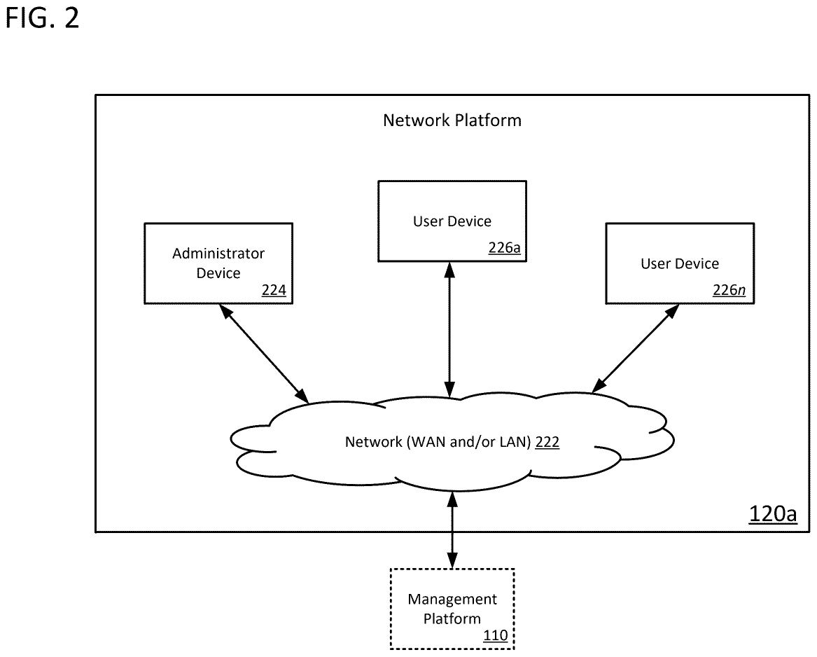

FIG. 2 illustrates an example network platform 120a of the network platforms 120a-120n, which operates as part of the broader device management environment depicted in FIG. 1, in accordance with some examples. The network platform 120a includes multiple interconnected devices, such as an administrator device 224 and various user devices 226a-226n, each connected through a network 222. The network 222 may represent a wide area network (WAN), a local area network (LAN), or a combination thereof, enabling communication among devices within the network platform 120a and with the management platform 110.

The administrator device 224 is used by an administrator or IT personnel responsible for managing configurations across user devices on the network platform 120a (and possibly other network platforms). The administrator device 224 communicates with the management platform 110 to configure and deploy configurations to the user devices on the network platform. Through the administrator device 224, administrators (also referred to herein as “users”) can send queries to the Agentic Configuration Assistance module, operating in some examples at the management platform 110, and receive structured assistance information therefrom.

The user devices 226a-226n represent endpoints (e.g., laptop computers, smartphones, desktop computers, tablet computers, etc.) on the network platform 120a that receive configurations managed by the management platform 110. Each user device may differ in terms of user role, device type, or network permissions, and thus may require specific configurations. Using configuration data defined by an administrator via the management platform 110, each user device 226a-226n can receive respective settings, applications, and policies based on the outcome of evaluated conditional logic nodes and associated Library Items (configurable data objects that define specific policies, applications, settings, or automation rules to be applied to managed user devices). These configurations ensure that each user device meets the organization's requirements for functionality and security.

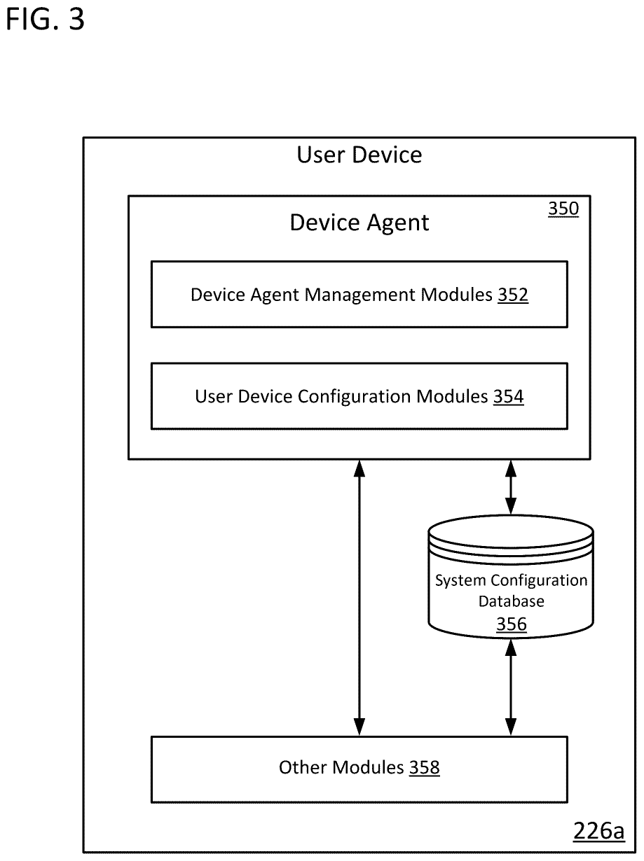

FIG. 3 depicts a simplified example of a user device 226a of the network platform 120a introduced in FIG. 2, in accordance with some examples. The user device 226a is configured to receive and implement configuration data generated by the management platform 110, thereby ensuring compliance of the user device 226a with organizational policies. In some examples, the user device 226a includes a device agent module 350, which operates in coordination with other components and modules on the user device to apply and monitor configurations provided by the management platform 110. In other words, the device agent 350 is central to receiving, processing, and enforcing the configuration data transmitted by the management platform 110. In some examples, the device agent 350 includes a first device agent associated with the management platform 110, as well as optional additional device agents that may be associated with an operating system or other software applications at a user device.

In some examples, the device agent 350 is installed at the user device 226a by the management platform 110. In other examples, the device agent 350 is installed, or is caused to be installed, on the user device 226a as part of a factory setup, pre-shipping setup, or reseller setup process of the user device 226a.

The device agent 350 comprises multiple modules, including device agent management modules 352, user device configuration modules 354, and other modules (not shown). The device agent management modules 352 handle communication with the management platform 110 (e.g., via the network 222 shown in FIG. 2), including receiving configuration data generated by the management platform 110. The device agent management modules 352 also transmit periodic, or event-driven, status updates back to the management platform 110 to indicate the success or failure of the user device configuration, as well as to provide logs of user device activity.

The user device configuration modules 354 configure the associated user device 226a in accordance with the configuration data received from the management platform 110 and as directed by the device agent management modules 352. This includes deploying the specified Library Items—such as security settings, application installations, or network configurations—on the user device 226a. The user device configuration modules 354 also handle any remediation steps necessary if the applied configuration is incomplete or encounters errors during execution.

The system configuration database 356 provides a local data store for configuration-related information, including the received configuration data, the status of deployed Library Items, and logs of prior configurations. The system configuration database 356 ensures that the user device 226a can enforce configurations and maintain compliance even in offline scenarios where direct communication with the management platform 110 is temporarily unavailable. Additionally, the system configuration database 356 may be configured to facilitate rollback or reapplication of configurations if updates or changes are required. In some examples, the system configuration database 356 is implemented as a file system repository, a relational database, a key-value store, a policy cache, or another local data structure accessible by the device agent 350.

The user device 226a may also include other modules 358, which support supplementary device operations that interact with the configuration data. These modules may include software for monitoring user device performance, enforcing local security policies, or providing user-specific settings. The other modules 358 work in coordination with the device agent 350 and the system configuration database 356 to ensure consistency and compliance with the organizational policies defined by the management platform 110.

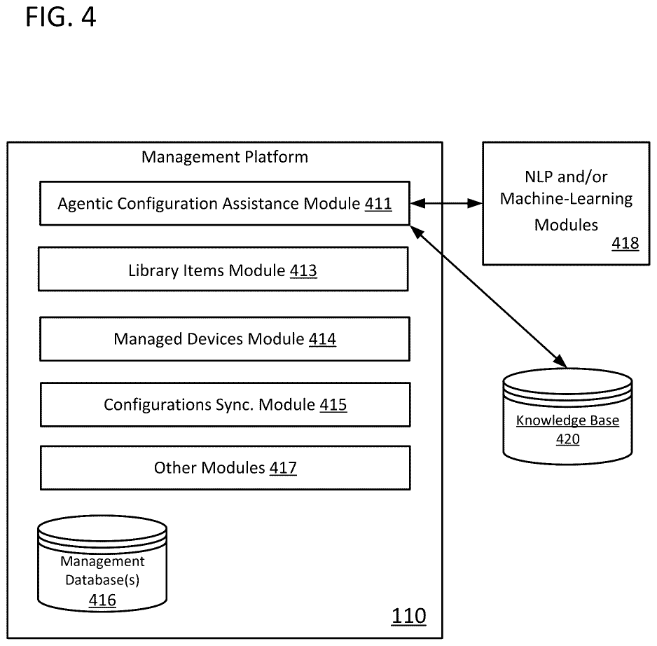

In accordance with some aspects, FIG. 4 illustrates a simplified portion of an example management platform 110. The management platform 110 is responsible for generating, managing, and distributing configuration data to user devices, such as the user device 226a depicted in FIG. 3, in accordance with some examples. The management platform 110 serves as a decentralized hub for defining and processing user device configurations, resolving conflicts, and ensuring configurations are effectively deployed and enforced across the network platforms 120a-120n of managed user devices.

The management platform 110 includes an Agentic Configuration Assistance module (ACAM) 411, which receives and refines user (i.e., administrator) queries, securely accesses the user's organizational configuration settings, knowledge base information, and other data sources, and provides natural language responses and accompanying illustrations to the user. In some examples, users access the ACAM 411 via a graphical user interface generated by the management platform 110 and which is accessed by the users (e.g., administrators at the administrator device 224) using a web portal. As described below, the ACAM 411 is operable to securely access MDM configuration data associated with a user query as well as to access, parse, and catalog user guides, instruction manuals, public knowledge base information, private knowledge base information, organizational policy documents, and any other relevant information.

The ACAM 411 communicates (e.g., via a network connection) with a local or remote NLP and/or machine-learning module 418. The ACAM 411 additionally communicates with a knowledge base 420, which is a network-accessible repository of public and private information relevant to the MDM management platform 110 (e.g., user guides, wikis, community-generated content, private API documentation, etc.). The NLP and/or machine-learning module 418 is operable to receive plain-language and data requests (e.g., user queries) via an API or other interface and generate natural-language assistance data (e.g., text and/or illustrated guidance) in response.

The Library Items module 413 manages a repository of configurations, applications, security settings, and other deployable assets. The Library Items module 413 ensures that the latest versions of these configurations are maintained and ready for deployment to user devices of the network platforms 120a-120n.

The Managed Devices module 414 tracks all user devices enrolled with the management platform 110. In some examples, this module maintains device-specific metadata, including device type, user roles, operating system versions, and compliance status. As such, the Managed Devices module 414 provides user device-specific information to the Agentic Configuration Assistance module 411, thereby enabling the ACAM 411 to provide contextually relevant information in response to user queries.

The Configuration Sync module 415 is responsible for the distribution of configuration data to associated user devices of the network platforms 120a-120n. This module ensures that configuration updates are efficiently synchronized with the appropriate user devices over a network connection, such as the network 222 shown in FIG. 2. It also monitors the status of synchronization processes, ensuring that updates are applied successfully and that any failures are flagged for remediation.

The management platform 110 may also include other modules 417, which provide supplementary functionality to enhance system performance or user experience. These modules may include analytics tools, auditing systems, or additional administrative controls.

One or more management databases 416 are used to store data essential to the operation of the management platform 110, such as Library Item version information, Library Items, user device metadata, and historical logs of configuration changes. The management databases 416 ensure that the management platform can maintain an accurate and comprehensive view of network-platform configuration states and support auditability for compliance purposes.

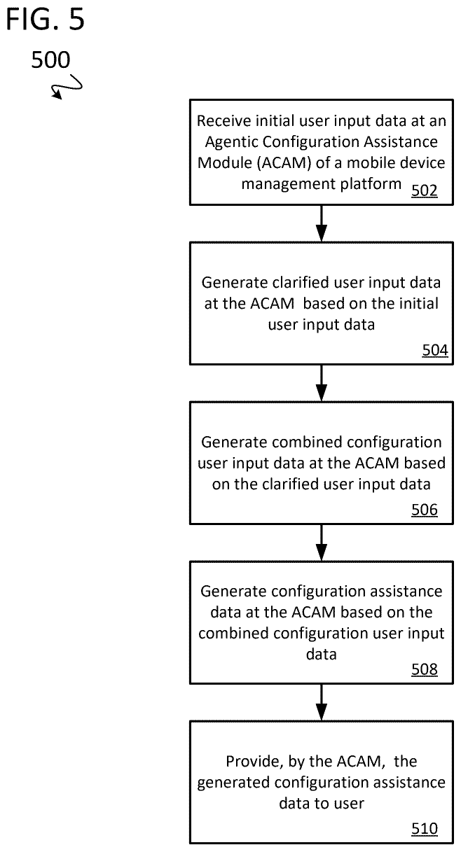

FIG. 5 illustrates a portion of a process 500 for providing contextually relevant assistance to a user of an MDM platform using an Agentic Configuration Assistance module (e.g., the ACAM 411), in accordance with some examples. The particular steps, order of steps, and combination of steps are shown for illustrative and explanatory purposes only. Other examples can implement different particular steps, orders of steps, and combinations of steps to achieve similar functions or results.

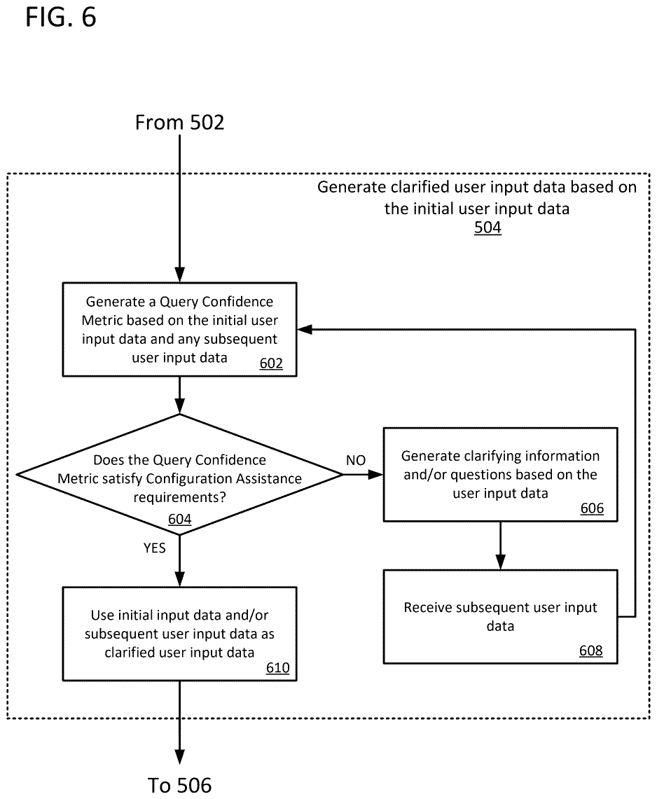

At step 502, the ACAM receives initial user input data (e.g., a query, in the form of text, image, or speech data) via a user interface (e.g., provided remotely by the management platform 110). At step 504, the ACAM conditionally iterates with the user via the user interface to clarify the user's request. Details of step 504 are described below with reference to FIG. 6.

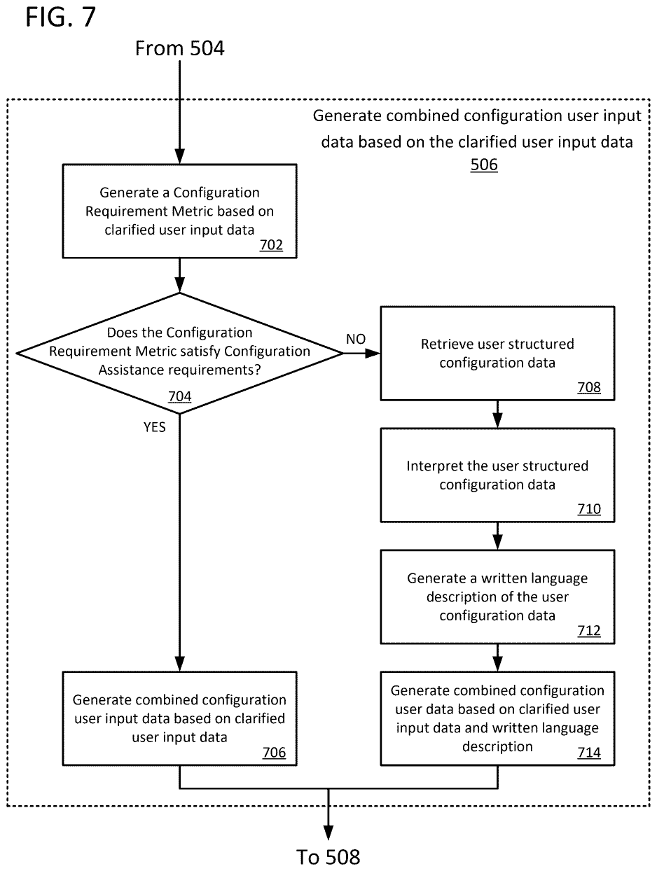

At step 506, the ACAM conditionally combines the clarified user request with general technical guidance (e.g., from user guides, knowledge base information, etc.) and with specific contextual information associated with the user's particular MDM configuration to generate combined configuration user input data. Details of step 506 are described below with reference to FIG. 7.

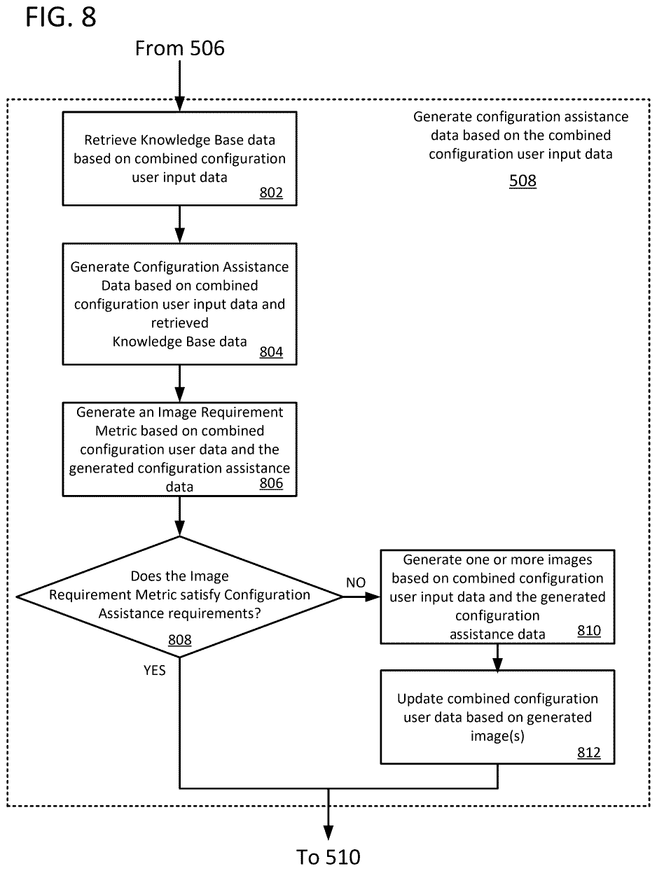

At step 508, the ACAM generates configuration assistance data (e.g., a response to the user's query) based on the combined configuration user input data. Details of step 508 are described below with reference to FIG. 8. Then, at step 510, the ACAM provides the generated configuration assistance data to the user (e.g., via a remote user interface generated by the management platform 110). As described below, the configuration assistance data may include text and illustrations that pertain to both general guidance as well as guidance that is specific to the user's MDM configuration. For example, the assistance data may include an illustration of the user's current MDM configuration and annotations specifying specific changes that a user might need to make to satisfy the initial request or query provided by the user to the ACAM. Based on the configuration assistance data, the user may then update an MDM configuration (e.g., by updating one or more settings or configurations of endpoints managed by the MDM, modifying or updating Library Items, changing security settings, etc.) using information derived from the configuration assistance data.

In some examples, after the configuration assistance data is presented at the user interface, the user interface enables a user to provide configuration input that specifies an updated configuration state (also referred to herein as a “second configuration”) that is derived at least in part from one or more configuration changes indicated by the configuration assistance data. For example, the generated configuration assistance data may identify one or more settings values, Library Item modifications, scope changes, or other configuration parameters to be applied via a user interface of the MDM. In some examples, the ACAM and/or another module of the MDM converts configuration input received at the user interface into one or more underlying machine-oriented configuration objects (e.g., using a translation map) and stores the resulting configuration state in one or more management databases as an updated configuration associated with the user or a selected group of managed devices. The management platform may then update a first configuration of the MDM in accordance with the second configuration by creating, modifying, enabling, disabling, or otherwise updating one or more Library Items and/or configuration records, and by associating such updated configuration records with selected managed devices, device groups, or deployment conditions. In some examples, after the first configuration is updated, a configuration synchronization module distributes updated configuration data to managed endpoints and monitors deployment status, thereby implementing the user-specified second configuration across one or more user devices.

FIG. 6 illustrates an example implementation of step 504 of the process 500 introduced with reference to FIG. 5, in accordance with some examples. The particular steps, order of steps, and combination of steps are shown for illustrative and explanatory purposes only. Other examples can implement different particular steps, orders of steps, and combinations of steps to achieve similar functions or results.

At step 602, the ACAM generates a Query Confidence Metric representative of how “confident” a natural language processing (NLP) or machine-learning module in communication with the ACAM is that the user's query and/or user intent underlying the user input data is understood by the NLP or machine-learning module. The Query Confidence Metric may be generated by the NLP or machine-learning module itself and may include a numerical confidence score, an uncertainty measurement, calibration of confidence scores (e.g., Platt scaling and/or temperature scaling), out-of-scope detection, context scoring, and/or other metrics known in the art. In some examples, the Query Confidence Metric additionally reflects whether key entities referenced in the user query have been identified, whether an action requested by the user has been mapped to a known configuration domain, whether conflicting interpretations remain, and/or whether available context is sufficient to proceed without additional clarification.

At step 604, the ACAM determines if the generated Query Confidence Metric meets configuration assistance requirements that may be specified by the MDM platform provider or by the user thereof. For example, if the Query Confidence Metric is implemented as a numerical value, determining that the Query Confidence Metric meets configuration assistance requirements may include determining that the numerical value meets or exceeds a configured numerical threshold value set by the user. If it is determined at step 604 that the Query Confidence Metric does not satisfy the configuration assistance requirements, flow continues to step 606. At step 606, the ACAM begins iteratively generating clarifying information and accompanying questions based on the user input data and presents the information and accompanying questions to the user.

As but one simplified example, a user may input a plain-language query of: “Our organization is exploring ways to streamline our device management process. We would like to know if there is a built-in capability—or a recommended custom solution—in the MDM that automatically assigns devices to a specific device configuration when a private identification is detected on a user device.”

In response to a Query Confidence Metric from the ACAM indicating that the received query does not satisfy the configuration assistance requirements, the ACAM may then generate the following example question: “Does your organization currently use any specific methods to manage devices based on user attributes? This could help in determining a potential workaround for your requirement.” In other examples, the ACAM may generate clarifying questions such as whether the requested behavior should apply to all managed devices or only a subset thereof, whether the user seeks an existing policy or an automation workflow, whether the triggering identifier is device-based or user-based, or whether a particular operating system or enrollment state is implicated by the request.

In response to the clarifying questions, the ACAM receives subsequent user input data via the user interface at step 608. Flow then returns to step 602 to generate an updated Query Confidence Metric based on the initial user input data, now elucidated by any subsequent user data. When the ACAM ultimately determines at step 604 that the Query Confidence Metric satisfies the defined configuration assistance requirements, the flow proceeds to step 610.

At step 610, the initial user input data and/or any subsequent user input data is used by the ACAM as “clarified user input data” for subsequent processing at step 506 introduced in FIG. 5.

FIG. 7 illustrates an example implementation of step 506 of the process 500 introduced with reference to FIG. 5, in accordance with some examples. The particular steps, order of steps, and combination of steps are shown for illustrative and explanatory purposes only. Other examples can implement different particular steps, orders of steps, and combinations of steps to achieve similar functions or results.

At step 702, the ACAM generates a Configuration Requirement Metric that is representative of whether MDM configuration data for the user's specific use context would result in a more informative response to the clarified user input data as compared to a response generated by the ACAM without the benefit of having specific MDM configuration data. For example, if the user has asked a general question concerning how to perform a common task, specific MDM configuration data may not be required by the ACAM to address the user's question. In contrast, if the user has asked how to perform a task related to the specific context of their MDM configuration, specific user MDM configuration data may be used by the ACAM as part of generating a response to the user's question. As such, the ACAM advantageously selectively uses organizational data which may be considered to be sensitive only when absolutely necessary.

In some examples, the Configuration Requirement Metric is generated by the ACAM based on the context and/or content of the user query. In some examples, the Configuration Requirement Metric is determined by the ACAM while attempting to generate a response to the user query as a background process and then subsequently determining whether the generated response pertains to the particulars of the user's MDM configuration. In some approaches, the Configuration Requirement Metric may be determined and evaluated by the ACAM using a method that is similar to the implementation of the Query Confidence Metric. For instance, the Configuration Requirement Metric may be more likely to indicate that structured configuration data should be used when the user query references a particular managed device, a particular policy object, a compliance state, a currently configured workflow, a device group, or another context-dependent administrative artifact.

If it is determined at step 704 that the Configuration Requirement Metric satisfies the configuration assistance requirements (i.e., structured configuration data is not needed or recommended), flow continues to step 706. At step 706, the ACAM generates the combined configuration user input data based on the clarified user input data and without an NLP-generated written-language description of the user's particular MDM configuration. Flow then continues to step 508, introduced with reference to FIG. 5.

If it is determined at step 704 that the Configuration Requirement Metric does not satisfy the configuration assistance requirements (i.e., structured configuration data is needed or recommended), flow continues to step 708.

At step 708, the ACAM retrieves structured configuration data that describes all or a portion of an MDM configuration associated with the user and the user's question (i.e., the user input data or clarified user input data). In some examples, the structured configuration data may include a representation of all or a portion of the Library Items that are applied within an MDM configuration and with which users the Library Items are associated. Which configuration details are included in the structured configuration data may be dependent on the scope of the user's question. In some examples, the structured configuration data may be an ordered listing of configuration details, a segmented listing (e.g., based on which endpoints are impacted, to which users or groups the configuration details apply), and/or a normalized representation of the configuration details. In some examples, the normalized representation may be a standardized representation of configuration details such that the ACAM may operate across multiple organizations using a standardized interface. In some examples, the normalized representation of configuration data within the structured configuration data may be a format that is conducive to processing by the ACAM 411. With reference to FIG. 4, in some examples, the ACAM 411 may request and retrieve configuration data from the Library Items module 413, the Managed Devices module 414, the Configuration Sync module 415, the management databases 416, and/or another module 417. The structured data may be, or include, JSON, YAML, XML, plist, and mobileconfig data formats, as well as other data. In some examples, the structured data includes one or more policy objects, payload values, rule definitions, device attributes, user-group associations, deployment conditions, compliance states, historical configuration records, synchronization states, or combinations thereof.

To ensure that the confidentiality of user data is fully respected, in some examples, specific configuration data is advantageously provided to the ACAM via an API call to NLP and machine-learning modules using a temporary vector store, as opposed to providing it directly within a prompt. For example, at step 708, after the user's MDM configuration data is retrieved by the ACAM, the ACAM may normalize the retrieved data, generate one or more text representations corresponding to semantically meaningful portions of the data, and upload those text representations and/or associated embeddings to a temporary vector store. The temporary vector store may then be attached to, referenced by, or otherwise made accessible to the NLP and/or machine-learning module.

In some examples, the temporary vector store is created specifically for the present assistance session and is assigned an identifier associated with the user session, the request, or both. Then, at step 710, the vector store is specified to the NLP and/or machine-learning module for use in interpreting the user's configuration data.

The vectorized data input represents a structured encoding of relevant device management parameters, such as user device attributes, applied policies, security settings, software configurations, and compliance states. In some examples, JSON and/or XML data may be uploaded directly to the vector store without extensive preprocessing. However, non-structured data may be preprocessed to normalize and/or standardize the data as part of, or preceding, the upload process. By preprocessing MDM configuration data into a vectorized format, the associated NLP or machine-learning module may dynamically interpret user queries in the context of the MDM configuration state, ensuring that responses and recommendations are adaptive, context-aware, and optimized for the specific MDM environment.

At step 712, the ACAM uses the NLP and/or machine-learning module and/or a translation map to generate a written-language description (e.g., text in the user's preferred language) of the provided configuration data. At step 714, the ACAM combines the written-language configuration description with the clarified user input data for subsequent use by the ACAM in formulating context-based assistance in response to the user's initial queries. In some examples, the ACAM uses a translation map to convert complex configuration designations into user-friendly language. For example, the ACAM may map a particular IP address, like “192.168.0.5,” to “HR Laptop,” or may translate text that a user sees within the MDM user interface (e.g., “Require Passcode”) to a Boolean object (e.g., “forcePasscode”) and vice versa. In this example, when the ACAM determines that the Boolean object “forcePasscode” needs to equal TRUE to address the user's query, the ACAM may format the response as “Please check the Require Passcode checkbox,” or similar. As such, the ACAM is operable to use one or more translation maps to translate a user-oriented data object (“HR Laptop”) to an underlying machine-oriented configuration object (“192.168.0.5”), as well as translate a machine-oriented configuration object (“forcePasscode”) to a user-oriented data object (“Require Passcode”).

After either step 712 or step 714, the temporary vector store associated with the user's structured configuration data is deleted, detached, expired, or otherwise rendered inaccessible by the ACAM to preserve the confidentiality of the user's data. As a result, the user's data is only presented ephemerally to the NLP and/or machine-learning module, with no, or a limited amount of, user-specific configuration data being persistently preserved by a third party following temporary data-store destruction. Flow then continues to step 508, introduced with reference to FIG. 5.

FIG. 8 illustrates an example implementation of step 508 of the process 500 introduced with reference to FIG. 5, in accordance with some examples. The particular steps, order of steps, and combination of steps are shown for illustrative and explanatory purposes only. Other examples can implement different particular steps, orders of steps, and combinations of steps to achieve similar functions or results.

At step 802, the ACAM retrieves knowledge base data that is pertinent to the combined configuration user input data. To ensure the NLP and/or machine-learning modules accessed by the ACAM are using the most up-to-date data, and that the data is made available most efficiently and with fidelity to the ACAM, vector stores are also used to store the knowledge base information. In some examples, the vector stores are updated in real time (e.g., event-driven) when any associated knowledge base article is published, as well as periodically. In such examples, the publishing of a knowledge base article triggers a vectorization script at the management platform 110, which takes the plain-text content of the article, sanitizes it (i.e., removes any HTML or Markdown formatting that is superfluous to the ACAM's use), chunks the article content, and outputs one or more text files or other intermediate representations, which are then uploaded to the vector store. This process may be carried out by the ACAM or another module of the management platform 110.

In some examples, metadata associated with the vectorized knowledge base content identifies an article, publication status, product version, access level, and/or content category. In some examples, public knowledge base content and private knowledge base content are stored in different logical partitions, indexes, namespaces, or other access-controlled portions of the vector store infrastructure.

In addition, in some examples, “Private Notes” are utilized in public knowledge base articles. Such Private Notes are sections of text contained within an article that are not visible publicly and are instead accessible only via an API or a logged-in internal user. This allows additional contextual knowledge to be injected into the ACAM's processing. Similar to how a human would have internal contextual knowledge of a particular subject matter and can augment written data therewith, the ACAM uses Private Notes as internal contextual knowledge, thereby allowing it to respond with knowledge and context that are not necessarily public-facing and that may provide a higher efficacy and quality of answer. In some examples, the ACAM selectively uses the Private Notes only for internal retrieval, reasoning, or ranking and omits private-note content from direct reproduction to a user unless access-control requirements are satisfied.

At step 804, the ACAM uses the combined configuration user input data and any retrieved knowledge base data to generate configuration assistance data (i.e., a response to the user's question) using a local or remote NLP or machine-learning module.

At step 806, based on the configuration assistance data generated at step 804, the ACAM generates an Image Requirement Metric which is representative of whether accompanying image data would help address the user's initial question. The Image Requirement Metric may be based on whether an MDM configuration change is suggested by the ACAM as part of a response to the user's query, whether the response concerns a particular interface location or sequence of interface actions, whether a visual comparison between a current configuration state and a recommended configuration state would be helpful, or whether the user has explicitly or implicitly requested visual guidance. If the Image Requirement Metric indicates, at step 808, (e.g., by surpassing a numerical threshold value) that accompanying image data would help address the user's query, flow continues to step 810. Otherwise, flow continues to step 510.

At step 810, the ACAM generates one or more images based on the combined configuration user input data. In some examples, image generation is accomplished by the ACAM by storing a master library of vector graphics (such as SVGs) and prompting an NLP or machine-learning module to determine a “diff” to the code for a relevant vector graphic containing the necessary alterations to illustrate the suggested configuration.

In some examples, a selected master vector graphic corresponds to a canonical user-interface state, such as a settings page, policy editor, status panel, workflow screen, or another interface view of the management platform 110. In some examples, the master vector graphic includes individually addressable graphical elements, such as groups, paths, text elements, icons, bounding boxes, callout anchors, layers, or other graphical primitives that can be modified independently.

For example, as vector graphics are stored as structured markup (XML in the case of SVGs), the diff may contain changes to the markup that the code of the respective master graphic can be patched with to display a given image. In some examples, the diff includes one or more of: a master-graphic identifier, an element identifier, an insertion instruction, a deletion instruction, a text substitution, an attribute-value modification, a style modification, a coordinate change, a highlighting instruction, an annotation instruction, a masking instruction, or combinations thereof. This approach is advantageous as compared to using a library of complete SVG images since each SVG image may include a large number of characters. As such, including complete SVG data as an input string to a machine-learning or NLP module as part of a prompt may be unfeasibly costly in terms of tokens and, in many cases, may exceed the maximum token input a commercially available machine-learning or NLP module will allow via API calls.

By using master graphic elements that are stored in vector format, a majority of the code does not need to be sent in the API prompt, and the returned diff only requires minimal token consumption. The ACAM then may use a marker in the diff to identify the master graphic from which the diff was created and patch the diff into a version of the master graphic code to be used to display the completed image to the user. In some examples, before rendering the completed image, the ACAM validates the diff by determining whether referenced element identifiers exist in the selected master graphic, whether requested changes satisfy one or more formatting or safety rules, and whether the resulting markup is syntactically renderable. This approach means that screenshots or screenshot-like interface illustrations can be created dynamically by the machine-learning or NLP modules, containing specific context to the user and their environment, without the need to store any sensitive data or train a model with it.

As one simplified example, if the ACAM determines that a response should recommend enabling a passcode requirement, the ACAM may select a master SVG corresponding to a policy-editing screen, obtain a diff that changes a graphical toggle state associated with the passcode setting, insert a highlight region around the relevant control, and add an annotation indicating the recommended action. The ACAM may then patch the diff into the selected master SVG and render the modified SVG for display with the generated configuration assistance data.

At step 812, the ACAM updates the combined configuration user input data based on any images generated at step 810. For example, at step 812, the combined configuration user input data may be annotated or illustrated with one or more generated images depicting current or recommended configuration settings. The process then continues to step 510, which was introduced with reference to FIG. 5.

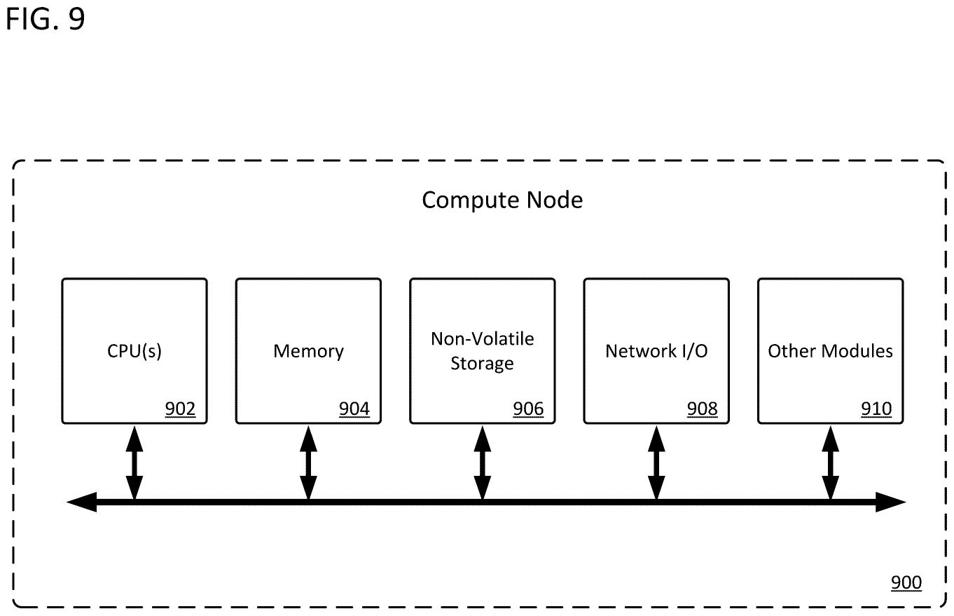

FIG. 9 illustrates an example compute node 900 having one or more processors that could be used as a hardware platform for implementing all or a portion of each of the management platform 110, the administrator device 224, and/or the user devices 226a-226n, in accordance with some aspects. The compute node 900 generally includes one or more CPUs 902 (e.g., processors), a memory module 904 (e.g., RAM), a non-volatile data storage module 906 (e.g., a hard drive, disk drive, or array of hard drives or disk drives), a network I/O module 908 (e.g., a network interface card (NIC) and/or a top-of-rack interface), and other modules 910 such as user I/O, wireless communication modules, optical communication modules, system diagnostic or monitoring modules, or other modules. The CPUs 902 are operable to perform processes in association with the memory module 904 and the non-volatile data storage module 906. In some examples, one or more compute nodes 900 are configured to perform all or a portion of the process 500 disclosed herein. In such examples, the memory module 904 and the non-volatile data storage module 906 may include all, or a portion of, the programs and data required by the CPUs 902 to perform the process 500 disclosed herein.

Reference has been made in detail to examples of the disclosed invention, one or more examples of which have been illustrated in the accompanying figures. Each example has been provided by way of explanation of the present technology, not as a limitation of the present technology. In fact, while the specification has been described in detail with respect to specific examples of the invention, it will be appreciated that those skilled in the art, upon attaining an understanding of the foregoing, may readily conceive of alterations to, variations of, and equivalents to these examples. For instance, features illustrated or described as part of one example may be used with another example to yield a still further example. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those skilled in the art will appreciate that the foregoing description is by way of example only, and is not intended to limit the invention.

What is claimed is:

1. A method, comprising:
receiving, by one or more processors of a mobile device management platform, initial user input data at an Agentic Configuration Assistance module (ACAM) associated with the mobile device management platform via a user interface;
generating, by the one or more processors, clarified user input data based on the initial user input data;
generating, by the one or more processors, a Configuration Requirement Metric based on the clarified user input data;
determining, by the one or more processors based on the Configuration Requirement Metric, whether structured configuration data associated with a first configuration of the mobile device management platform is to be used in responding to the clarified user input data;
in response to determining that the structured configuration data is to be used, retrieving, by the one or more processors, the structured configuration data associated with the first configuration from the mobile device management platform, and generating combined configuration user input data based on the clarified user input data and information derived from the structured configuration data;
in response to determining that the structured configuration data is not to be used, generating, by the one or more processors, the combined configuration user input data based on the clarified user input data without using the structured configuration data;
generating, by the one or more processors, configuration assistance data based on the combined configuration user input data;
providing, by the one or more processors, the configuration assistance data via the user interface;
receiving, by the one or more processors, a configuration input via the user interface, the configuration input specifying a second configuration of the mobile device management platform and derived at least in part from one or more configuration changes indicated by the configuration assistance data; and
updating, by the one or more processors, the first configuration of the mobile device management platform based on the second configuration.

2. The method of claim 1, wherein:
the structured configuration data comprises data representative of all or a portion of an existing configuration for the mobile device management platform associated with the clarified user input data.

3. The method of claim 1, wherein generating the clarified user input data comprises:
generating, by the one or more processors, a Query Confidence Metric based on the initial user input data;
determining whether the Query Confidence Metric satisfies a specified configuration assistance requirement; and
in response to determining that the Query Confidence Metric does not satisfy the specified configuration assistance requirement:
generating clarifying information based on the initial user input data;
providing the clarifying information via the user interface;
receiving subsequent user input data; and
generating an updated Query Confidence Metric based on the initial user input data and the subsequent user input data.

4. The method of claim 1, wherein generating the combined configuration user input data comprises:
generating, by the one or more processors, a written-language description of at least a portion of the structured configuration data; and
generating, by the one or more processors, the combined configuration user input data based on the clarified user input data and the written-language description.

5. The method of claim 1, further comprising:
translating, by the one or more processors, all or a portion of the initial user input data or clarified user input data to an underlying machine-oriented configuration object using a translation map.

6. The method of claim 1, further comprising:
translating, by the one or more processors, all or a portion of a machine-oriented configuration object to a plain-language description that is included in the configuration assistance data using a translation map.

7. The method of claim 1, wherein retrieving the structured configuration data comprises:
normalizing, by the one or more processors, at least a portion of configuration data associated with a configuration of the mobile device management platform to generate a normalized representation of the configuration data;
uploading, by the one or more processors, the normalized representation of the structured configuration data to a temporary vector store; and
making, by the one or more processors, the temporary vector store accessible to a natural language processing module for use in generating the configuration assistance data.

8. The method of claim 7, further comprising:
after generating the configuration assistance data, rendering, by the one or more processors, the temporary vector store inaccessible to the natural language processing module.

9. The method of claim 1, wherein:
generating the configuration assistance data comprises retrieving knowledge base data pertinent to the combined configuration user input data and generating the configuration assistance data based on the combined configuration user input data and the retrieved knowledge base data.

10. The method of claim 9, wherein:
the knowledge base data includes public knowledge base content and private knowledge base content.

11. The method of claim 1, further comprising:
generating, by the one or more processors, an Image Requirement Metric representative of whether accompanying image data would help address a request represented by the combined configuration user input data; and
in response to determining that the Image Requirement Metric satisfies a specified configuration assistance requirement, generating, by the one or more processors, one or more images based on the combined configuration user input data and the configuration assistance data.

12. The method of claim 11, wherein:
generating the one or more images comprises:
selecting, by the one or more processors, a master vector graphic corresponding to a canonical user-interface state of the mobile device management platform;
obtaining, by the one or more processors, a graphical difference identifying one or more alterations to the master vector graphic; and
patching, by the one or more processors, the graphical difference into the master vector graphic to generate a modified vector graphic for display with the configuration assistance data.

13. A non-transitory computer-readable medium storing instructions for executing a computer-implemented method, the computer-implemented method comprising:
receiving, by one or more processors of a mobile device management platform, initial user input data at an Agentic Configuration Assistance module (ACAM) associated with the mobile device management platform via a user interface;
generating, by the one or more processors, clarified user input data based on the initial user input data;
generating, by the one or more processors, a Configuration Requirement Metric based on the clarified user input data;
determining, by the one or more processors based on the Configuration Requirement Metric, whether structured configuration data associated with a first configuration of the mobile device management platform is to be used in responding to the clarified user input data;
in response to determining that the structured configuration data is to be used, retrieving, by the one or more processors, the structured configuration data associated with the first configuration from the mobile device management platform, and generating combined configuration user input data based on the clarified user input data and information derived from the structured configuration data;
in response to determining that the structured configuration data is not to be used, generating, by the one or more processors, the combined configuration user input data based on the clarified user input data without using the structured configuration data;
generating, by the one or more processors, configuration assistance data based on the combined configuration user input data;
providing, by the one or more processors, the configuration assistance data via the user interface;
receiving, by the one or more processors, a configuration input via the user interface, the configuration input specifying a second configuration of the mobile device management platform and derived at least in part from one or more configuration changes indicated by the configuration assistance data; and
updating, by the one or more processors, the first configuration of the mobile device management platform based on the second configuration.

14. The computer-implemented method of claim 13, wherein generating the clarified user input data comprises:
generating, by the one or more processors, a Query Confidence Metric based on the initial user input data;
determining whether the Query Confidence Metric satisfies a specified configuration assistance requirement; and
in response to determining that the Query Confidence Metric does not satisfy the specified configuration assistance requirement:
generating clarifying information based on the initial user input data;
providing the clarifying information via the user interface;
receiving subsequent user input data; and
generating an updated Query Confidence Metric based on the initial user input data and the subsequent user input data.

15. The computer-implemented method of claim 13, wherein generating the combined configuration user input data comprises:
generating, by the one or more processors, a written-language description of at least a portion of the structured configuration data; and
generating, by the one or more processors, the combined configuration user input data based on the clarified user input data and the written-language description.

16. The computer-implemented method of claim 13, further comprising:
translating, by the one or more processors, all or a portion of the initial user input data or clarified user input data to an underlying machine-oriented configuration object using a translation map.

17. The computer-implemented method of claim 13, further comprising:
translating, by the one or more processors, all or a portion of a machine-oriented configuration object to a plain-language description that is included in the configuration assistance data using a translation map.

18. The computer-implemented method of claim 13, wherein retrieving the structured configuration data comprises:
normalizing, by the one or more processors, at least a portion of configuration data associated with a configuration of the mobile device management platform to generate a normalized representation of the configuration data;
uploading, by the one or more processors, the normalized representation of the structured configuration data to a temporary vector store; and
making, by the one or more processors, the temporary vector store accessible to a natural language processing module for use in generating the configuration assistance data.

19. The computer-implemented method of claim 13, wherein:
generating the configuration assistance data comprises retrieving knowledge base data pertinent to the combined configuration user input data and generating the configuration assistance data based on the combined configuration user input data and the retrieved knowledge base data.

20. The computer-implemented method of claim 13, further comprising:
generating, by the one or more processors, an Image Requirement Metric representative of whether accompanying image data would help address a request represented by the combined configuration user input data; and
in response to determining that the Image Requirement Metric satisfies a specified configuration assistance requirement, generating, by the one or more processors, one or more images based on the combined configuration user input data and the configuration assistance data.
